(19) United States
(12) Patent Application Publication
(10) Pub. No.: US 2012/0051879 A1
(43) Pub. Date: Mar. 1, 2012

(54) MOTION CONTROL SYSTEM AND MOTION CONTROL PROCESS

(75) Inventors: Adam DAVIS, Lancaster, PA (US); Tyler Kicera, Manheim, PA (US); Matt Hales, Lancaster, PA (US)

(73) Assignee: TAIT TOWERS INC., Lititz, PA (US)

(21) Appl. No.: 12/862,407

(22) Filed: Aug. 24, 2010

(51) Int. Cl. G05D 1/00; B66F 9/00; B66C 3/00; G01C 19/00

(52) U.S. Cl. 414/729; 74/5.34; 414/680; 248/550

(57) ABSTRACT

Provided is a system and process of controlling motion. The system and process provide a force to substantially maintain a relative position in response to an external force being applied to at least one of one or more movable members or generate an internal force to adjust the relative position.

### FIELD OF THE DISCLOSURE

The present disclosure generally relates to platform systems and processes involving platform systems. More specifically, the present invention relates to systems processes for stabilizing or moving platforms.

### BACKGROUND OF THE DISCLOSURE

When a platform is hung from cables, the platform is subjected to forces causing the platform to move by swaying, rotating, and/or becoming unstable. For example, external forces on the cables can cause the platform to move, external forces on a body connected to the cables can cause the platform to move, and/or external forces such as wind can cause the platform to move. Additionally, internal movement from structures attached to the platform can cause the platform to move. For example, lighting structures attached to the platform can cause the platform to move when the lighting structures rotate.

In a known system, some of the internal forces are dampened. In WO 2009/010727, assigned to the Royal Shakespeare Company and titled “Oscillation Damper,” hereinafter “the '727 application,” which is incorporated by reference in its entirety, internal forces generating oscillatory motion are dampened by one or more gyroscopes. The gyroscopes are activated based upon an oscillating motion being detected through a sensor such as an accelerometer. The oscillating motion is dampened by providing a corresponding harmonic motion. The Oscillating Damper suffers from several drawbacks. For example, the Oscillating Damper only responds to movement that is associated with oscillating motion. In addition, the systems of the '727 application involving Oscillating Damper are limited to those having internal forces. In addition, non-patent literature from the Royal Shakespeare Company at www.rsclightlock.com dated May 18, 2010, which is incorporated by reference in its entirety, seems to further describe the limitations of the Oscillation Damper. Specifically, drawbacks identified by the Royal Shakespeare Company are that the Oscillation Damper will only correct oscillations due to something that is connected to the structure and cannot dampen movement by an external force.

Alternatively, controlled motion of a system can be desirable. Although movement of a platform can compromise safety, such movement can be incorporated into a theatrical presentation, a repetitive process such as repositioning of items or loads, or other suitable controlled motions.

What is needed is a system and process capable of responding to external forces and/or generating controlled motion.

### SUMMARY OF THE DISCLOSURE

One aspect of the disclosure refers a system including a platform, a motion control mechanism affixed to the platform, a body, and one or movable members extending between the platform and the body to support the platform. The one or more movable members connects the platform to the body. The motion control mechanism is configured to provide a force to substantially maintain a relative position of the platform in response to an external force being applied to at least one of the one or more movable members or the platform or the motion control mechanism is configured to adjust the relative position of the platform by generating an internal force.

Another aspect of the disclosure refers to a process of providing motion control to a system having a platform, a motion control mechanism, and a body. The process includes supporting the platform with one or more movable members extending between the platform and the body and providing a force to maintain a relative position of the platform with the motion control mechanism in response to an external force being applied to at least one of the one or more movable members or the platform or generating an internal force to adjust the relative position of the platform.

Another aspect of the disclosure refers to a process of controlling motion of a system. The process includes providing a force to substantially maintain a relative position of a platform in response to an external force being applied to at least one of one or more movable members or the platform or generating an internal force to adjust the relative position of the platform.

An advantage of embodiments of the present disclosure is that external forces can be dampened thereby preventing platforms from being unstable.

Another advantage of embodiments of the present disclosure is that operators can have further control of platforms.

Yet another advantage of embodiments of the present disclosure is that individuals on, below, or around the system can be protected from harm associated with things falling from platforms.

Yet another advantage of embodiments of the present disclosure is that individuals can be raised and lowered on platforms at a faster rate with a decreased risk of injury due to loss of balance caused by unstable platforms.

Yet another advantage of embodiments of the present disclosure is that a platform can be moved along a path by generating an internal force for aesthetic or industrial functions.

Further aspects of the method and system are disclosed herein. The features as discussed above, as well as other features and advantages of the present disclosure will be appreciated and understood by those skilled in the art from the following detailed description and drawings.

### BRIEF DESCRIPTION OF THE DRAWINGS

FIG. 1 shows a perspective view of a retracted system in a performance setting according to an exemplary embodiment of the disclosure.

FIG. 2 shows a perspective view of an expanded system in a performance setting according to an exemplary embodiment of the disclosure.

FIG. 3 shows a side view of a system in a performance setting according to an exemplary embodiment of the disclosure.

FIG. 4 shows a side view of a system in a performance setting according to an exemplary embodiment of the disclosure.

FIG. 5 shows a perspective view of a system having a crane as a body according to an exemplary embodiment of the disclosure.

FIG. 6 shows a perspective view of a system having a crane as a body according to an exemplary embodiment of the disclosure.

FIG. 7 shows a perspective view of a system having a body resting on the ground according to an exemplary embodiment of the disclosure.

FIG. 8 shows a perspective view of a system having a vehicle as a body according to an exemplary embodiment of the disclosure.

FIG. 9 shows a perspective view of a system having a vehicle as a body that is secured to the ground according to an exemplary embodiment of the disclosure.

FIG. 10 shows a perspective view of a system having a crane as a body according to an exemplary embodiment of the disclosure.

FIG. 11 shows a perspective view of a system having a crane as a body according to an exemplary embodiment of the disclosure.

FIG. 12 shows a side view of a system in a performance setting capable of torsional movement according to an exemplary embodiment of the disclosure.

### DESCRIPTION OF THE DISCLOSURE

Provided is a system and process to substantially maintain a relative position of a platform in response to an external force being applied or to generate an internal force thereby providing controlled motion. Embodiments of the present disclosure damp external forces thereby preventing platforms from being unstable, permit operators to have further control of platforms, protect individuals on or around the system from harm associated with things falling from platforms, permit individuals to be raised and lowered on platforms at a faster rate with a decreased risk of injury due to loss of balance caused by unstable platforms, and/or permit a platform to be moved along a path by generating an internal force for aesthetic or industrial functions.

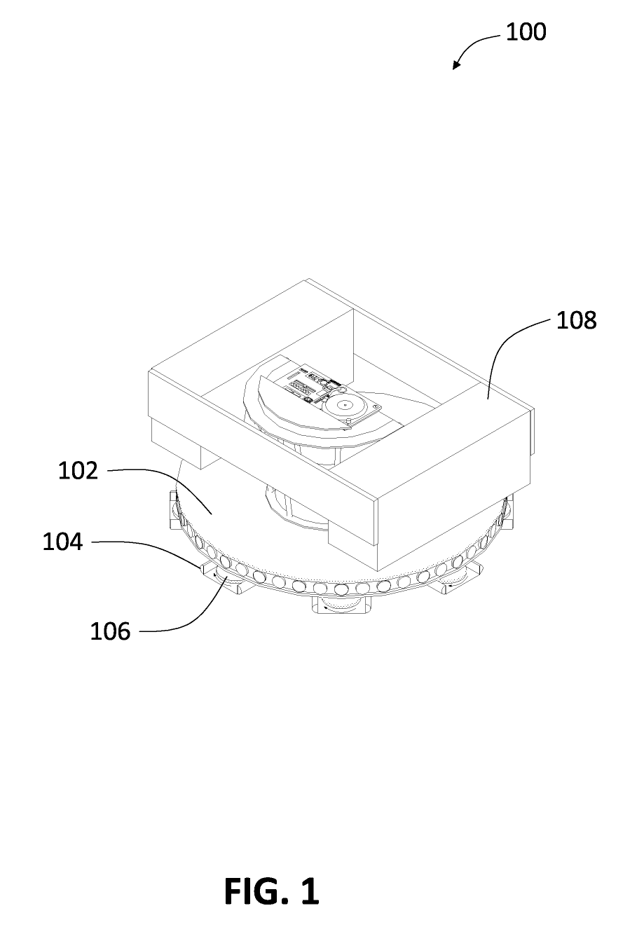

FIG. 1 shows a perspective view of a retracted or consolidated system 100 according to an embodiment. The system 100 includes a platform 102, a motion control mechanism 104, a body 108, and one or more movable members 204 supporting the platform 102. As used herein, the term “movable” describes being capable of substantial movement that may generate or exacerbate a force. For example, one or more rigid members can be connected together to form a movable member. The one or more movable members 204 connect the platform 102 to the body 108.

In one embodiment, the motion control mechanism 104 is configured to provide a force or forces that substantially maintain a relative position of the platform 102 or stabilize the platform 102. As used herein the term “external force” refers to a force generated from outside of the platform 102. For example, a force generated from movement of a robotic or movable light hanging from the platform 102 is not an external force. However, a force generated from movement of one of the movable members 204 is an external force. Other external forces include, but are not limited to, force generated from movement of the body 108 and force generated from wind. Furthermore, a force generated from an individual on the platform 102 is an external force. For example, the individual can be dancing, jumping, clapping, or playing an instrument. Such activities can result in an external force being generated. Additionally, in one embodiment, the individual can be loosely tethered to the platform 102 for safety purposes and provide external force to the platform 102; however, in this embodiment, any force transferred from the individual through the tether to the platform 102 is not considered an external force. However, an individual hanging from the platform 102 does not generate an external force.

In one embodiment, the motion control mechanism 104 maintains the relative position of the platform 102 by responding to a signal corresponding with a sensed or anticipated external force. For example, upon receiving the signal (which may be initiated based upon a control system described below), the motion control mechanism 104 activates one or more rotatable weights (for example, a gyroscope 106 or a flywheel). The gyroscopes 106 rotate to provide a force in a direction opposite the external force. The gyroscopes 106 can be accelerated at a predetermined rate and/or rotated at a predetermined velocity to compensate for the external force being at a predetermined amount. The movement of the gyroscopes 106 can reduce or eliminate movement of the platform 102. With complex external forces, multiple gyroscopes 106 can be arranged on, below, or within the platform 102 to compensate in different planes. For example, if the external force being applied is in a tangential direction, a first gyroscope 106 positioned in a first orientation and a second gyroscope 106 positioned in a second orientation that is perpendicular to the first orientation can work together to compensate for the external force. In this embodiment, the first gyroscope 106 will compensate in a first direction and the second gyroscope 106 will compensate in a second direction that can be combined as vectors to compensate in a direction opposite the tangential direction. In one embodiment, three gyroscopes are arranged in different orientations to compensate for an external force in any direction.

By responding to the signal corresponding to a sensed or anticipated external force, the gyroscopes 106 can substantially maintain the relative position of the platform 102. For example, the relative position of the platform 102 can be substantially maintained during application of an external force oriented substantially consistent with the orientation of the movable members 204 (for example, a force generated by using a winch to retract the movable members 204). Similarly, the relative position of the platform 102 can be substantially maintained during application of an external force oriented substantially perpendicular with the orientation of the movable members 204 (for example, a force generated by moving the body 108 along a predetermined path). In one embodiment, the gyroscopes 106 maintain a substantially level (to the ground, another suitable surface, and/or the body 108) platform 102 by being configured to substantially maintain a relative distance between a plurality of locations 206 on the platform 102 and a surface 208 while the external force is being applied. In one embodiment, the plurality of locations 206 includes a first location 205 and a second location 207. In this embodiment, the platform 102 cannot be fully balanced. In another embodiment, the plurality of locations includes the first location 205, the second location 207, and a third location 209. In this embodiment, the platform 102 can be fully balanced.

In another embodiment, the motion control mechanism 104 adjusts the relative position of the platform 102 by generating an internal force through adjustment of the motion control mechanism 104 and/or the gyroscope 106. The adjustment can be in response to a signal corresponding with a sensed or anticipated external force, a predetermined path for the platform 102, random, or based upon any suitable process. The adjustment can be performed manually (for example, by a controller remote from the platform 102 and/or by a performer on the platform 102) or automatically (for example, based upon a control program/process). The adjustment can be an orientation adjustment, a velocity adjustment, an acceleration adjustment, a rate of acceleration adjustment, a halting adjustment, any other suitable adjustment, or a combination thereof The adjustment can be an increase, a decrease, or maintaining of the parameter in response to a control program/process. For example, upon receiving a signal initiated based upon a control system/process, the motion control mechanism 104 can activate one or more rotatable weights (for example, the gyroscope 106 or a flywheel). The gyroscope(s) 106 rotate, and the motion control mechanism 104 is adjusted.

In one embodiment, one or more of the motion control mechanism 104 can be adjusted by an orientation adjustment. The orientation adjustment generates an internal force thereby adjusting the relative position of the platform 102. For example, the orientation can be adjusted by repositioning the motion control mechanism 104 from a horizontal position to a vertical position in relation to the platform 102. Additionally or alternatively, the orientation can be adjusted by repositioning the motion control mechanism 104 by rotating it 180 degrees.

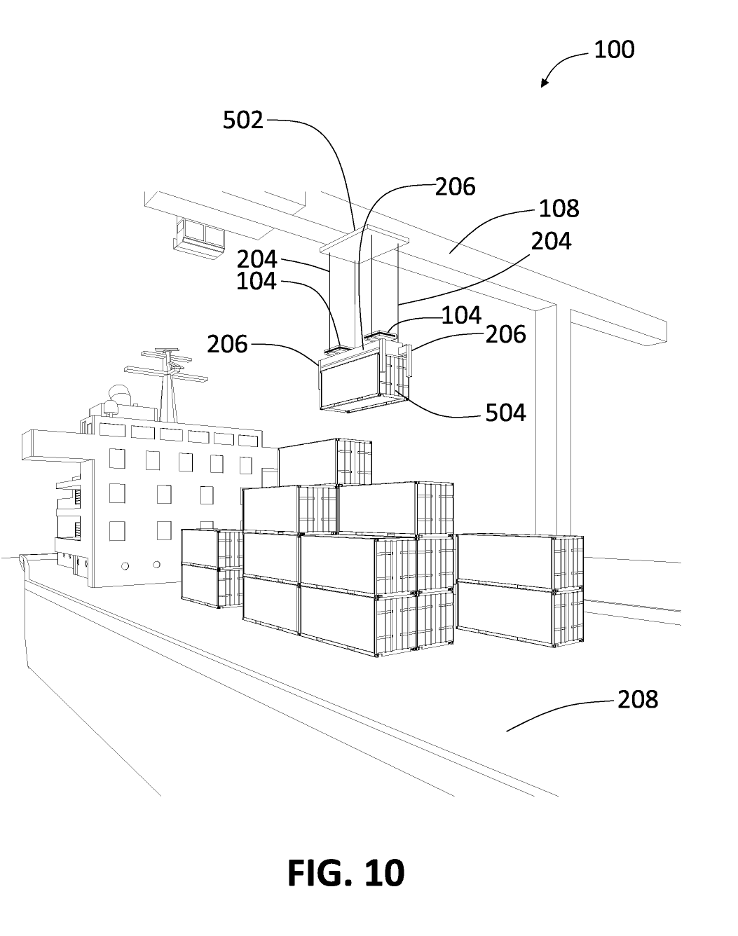

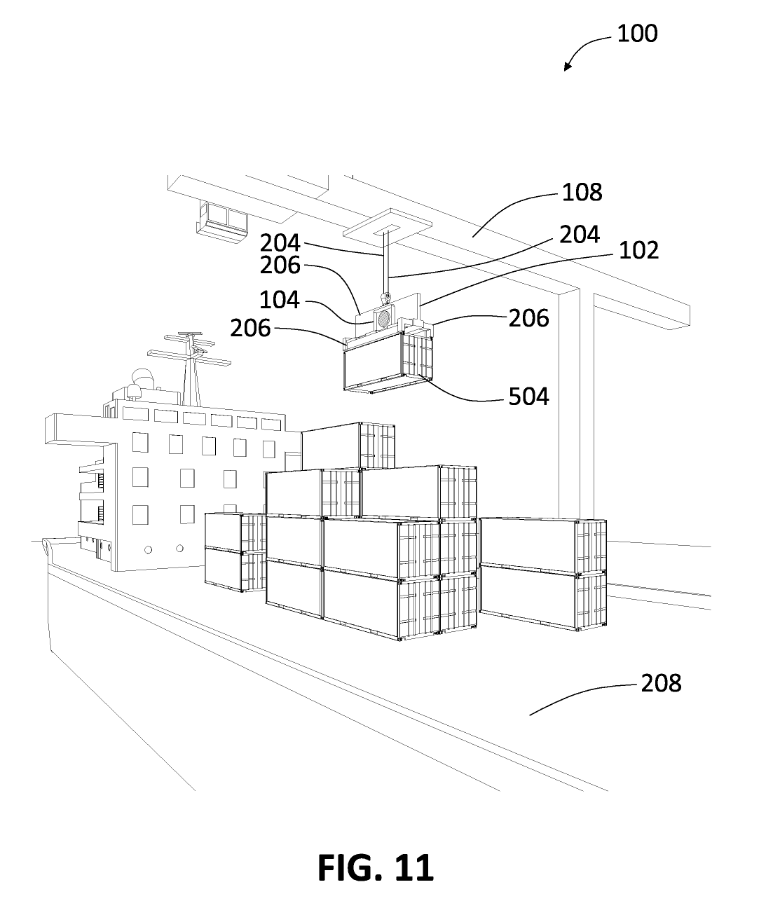

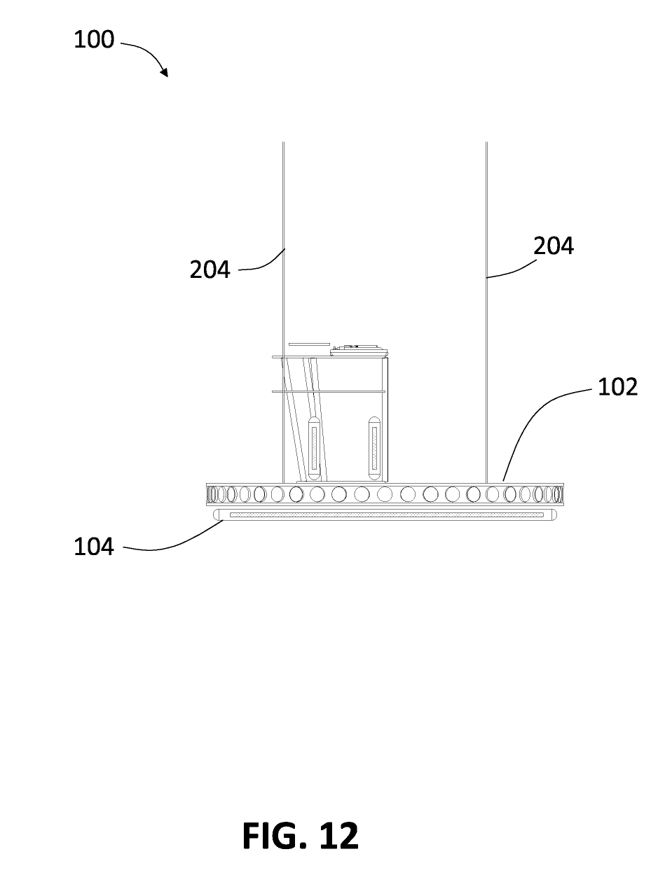

A complex dynamic system integrating one or more of these parameters permits the motion control mechanism 104 to dynamically respond to external forces and/or to dynamically generate internal forces. With complex operational processes being desired, multiple gyroscopes 106 can be arranged on, below, or within the platform 102 to compensate in different planes. For example, if the operational process includes adjusting the relative position of the platform 102 in a tangential direction, a first gyroscope 106 positioned in a first orientation and a second gyroscope 106 positioned in a second orientation that is perpendicular to the first orientation can work together (having a range relative force that can be generated) to adjust the relative position of the platform 102 in the tangential direction. In this embodiment, the first gyroscope 106 will generate force in a first direction and the second gyroscope 106 will generate force in a second direction that can be combined as vectors to generate in the tangential direction. In one embodiment, three gyroscopes are arranged in different orientations to compensate for an external force in any direction. Likewise, adjusting the gyroscopes 106 as described above can be incorporated into the complex dynamic system. In one embodiment, gyroscopes 106 of differing size, mass, and operational parameters are used for dynamically generating internal forces according to the operational process. For example, as shown in FIGS. 10-11, the gyroscopes 106 can have a large size and/or mass to selected based upon the anticipated external forces or desired internal forces to be generated. In one embodiment, the weight of the one or more gyroscopes 106 is so large that external forces have negligible effect on moving the platform 102. In this embodiment, movement of the one or more gyroscopes 106 generally controls movement of the platform 102. In one embodiment, the complex dynamic system is capable of generating an internal force that results in torsional movement of the platform 102. For example, when a single large gyroscope 106 is attached to the platform 102, as shown in FIG. 12, a substantial torsional force with significant movement of the platform 102 can be generated by rotating the gyroscope 106 and then substantially immediately halting the gyroscope 106 (for example, by actuating a brake, clutch, or peg). Such substantially immediate halting of the gyroscope 106 causes the platform 102 to tilt or spin or can cause erratic unpredictable movement.

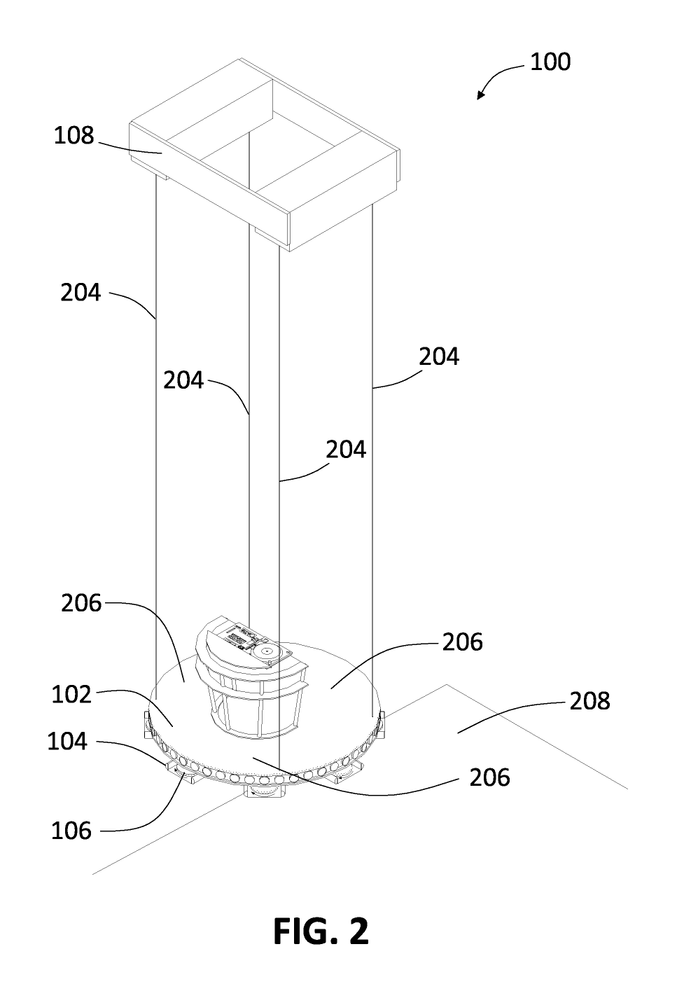

The platform 102 can be any suitable platform. The platform 102 can be square, circular, ovular, rectangular, or any other suitable shape. The platform 102 can be a portion of any object having a substantially planar surface. For example, the platform 102 can be a crate, a box, a stage, a floor, a plurality of tubes, a truss, or any other suitable structure. The platform 102 can be made of any suitable material or materials. In embodiments with a heavier platform (for example, a steel platform, metal platform, wood platform, glass), the gyroscopes 106 include heavier rotatable weights or greater number of gyroscopes permitting an increased amount of compensation for handling an external force. In some embodiments with a lighter platform (for example, plastic platforms, certain composite platforms, and hollow platforms), the gyroscopes 106 are of a lighter weight to reduce or eliminate over-compensation. The weight of the gyroscopes 106 and/or the overall capacity for compensation of the motion control mechanism 104 can correspond to a predetermined range of anticipated external forces. For example, the platform 102 shown in FIG. 1 can be lowered to the position in FIG. 2. Lowering the platform 102 results in a predictable range of external force being applied by the movement of the movable members 204. Identifying the applicable range permits the gyroscopes 106 to be configured for a range of weight based upon the weight of the platform 102, the weight of an individual likely to use the platform 102 (for example, a performer), and/or the weight of items positioned on the platform 102 (for example, a turn-table or other disc jockey equipment).

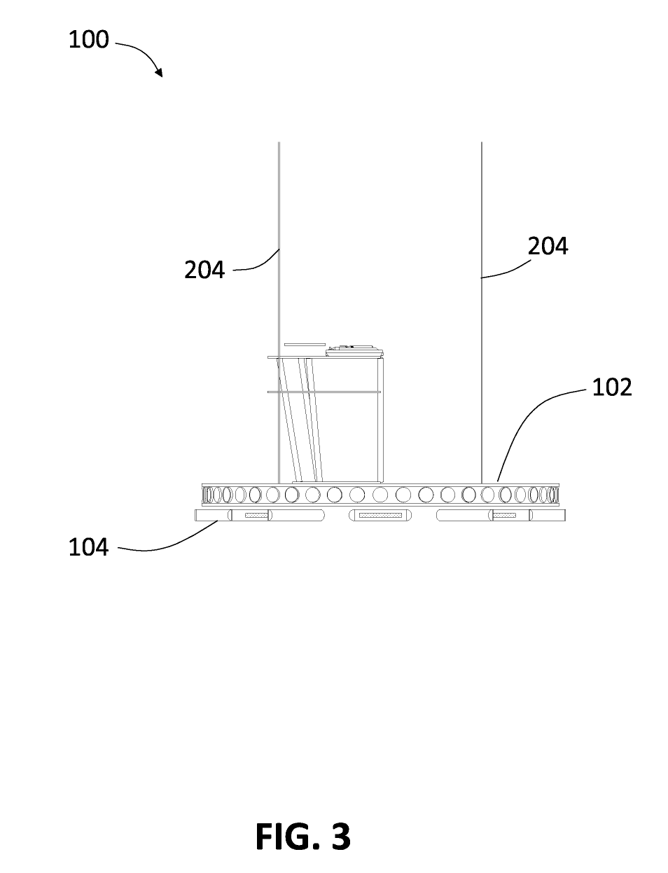

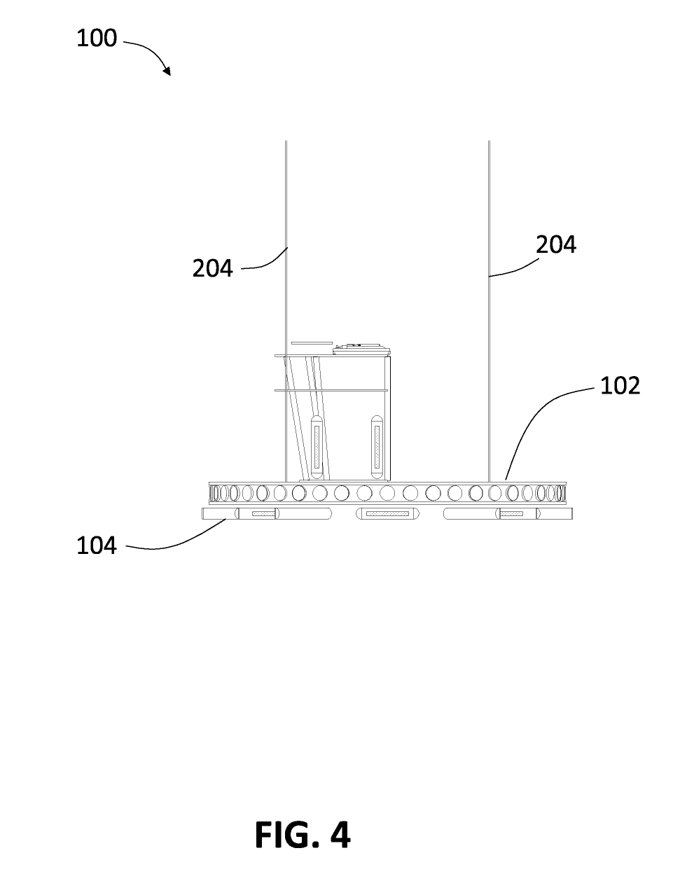

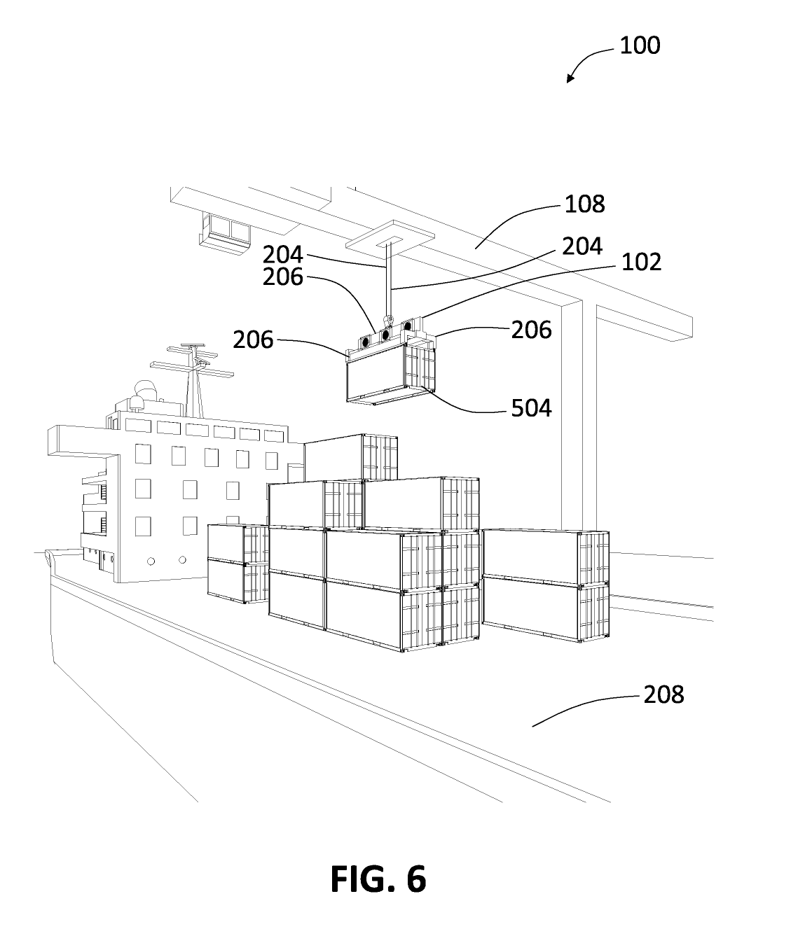

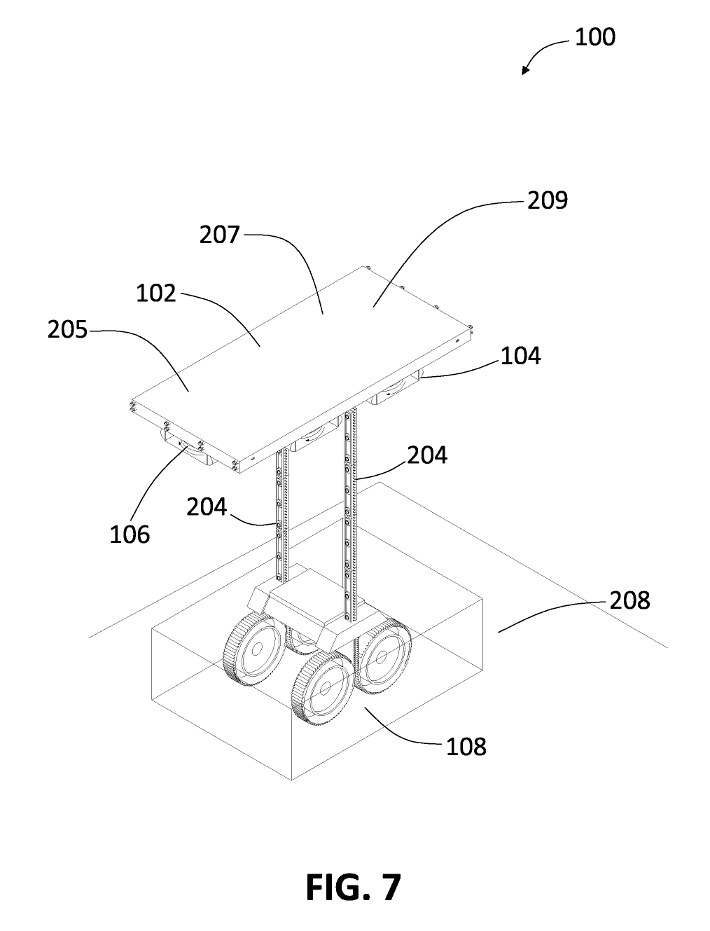

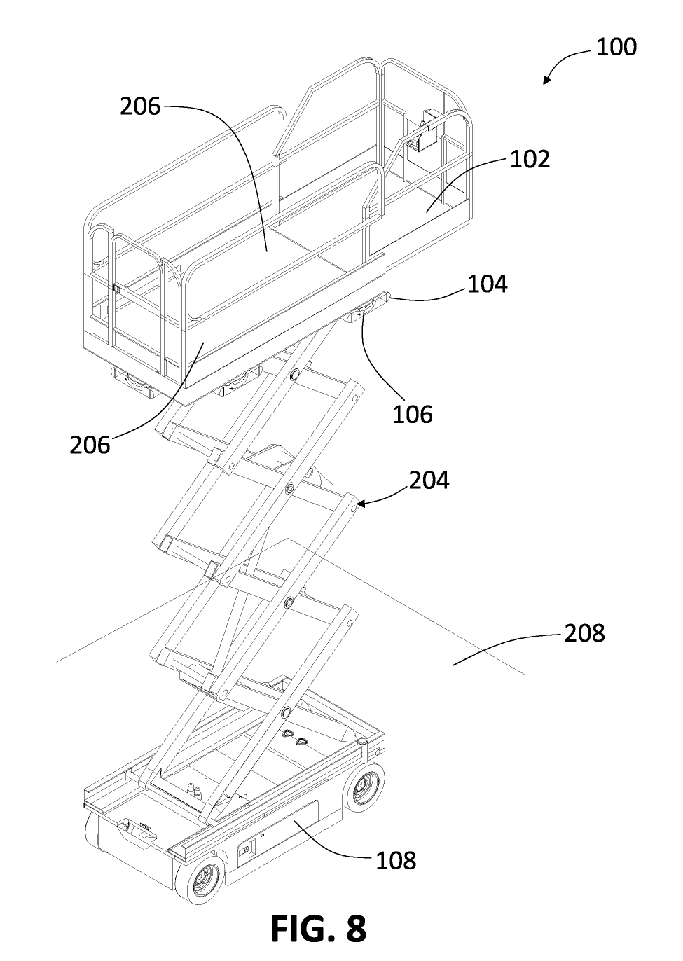

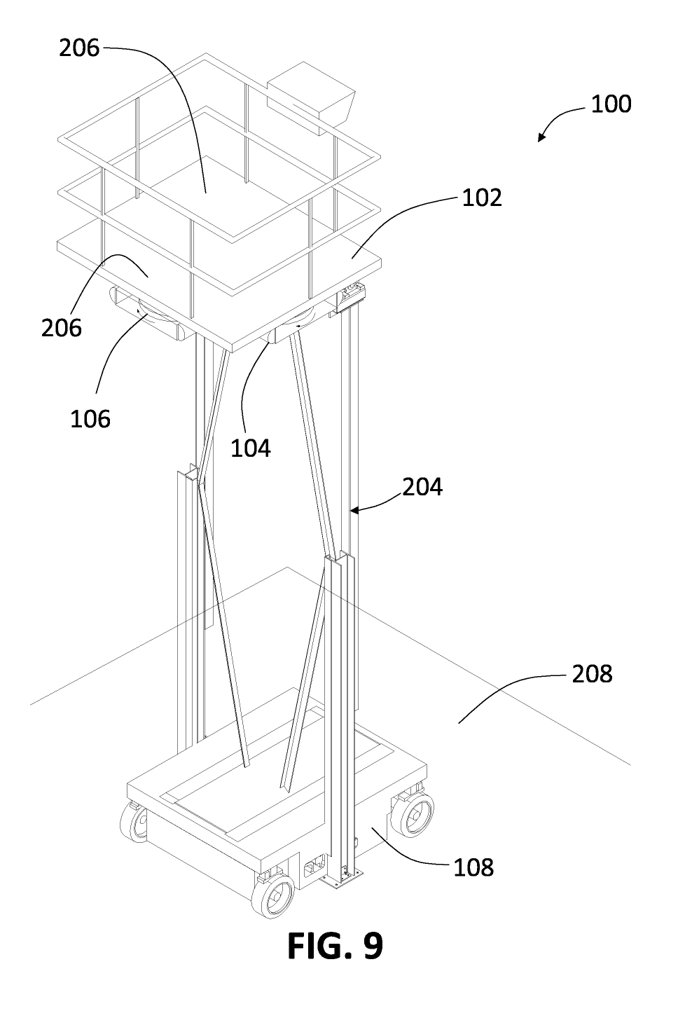

The movable members 204 support the platform 102 and any items on the platform 102. In one embodiment, the movable members 204 are the only load-bearing members within the system 100. The movable members 204 can be directly or indirectly and/or permanently or detachably attached to the platform 102. In one embodiment, the movable members 204 are attached to the platform 102 and can be detached upon the platform 102 reaching a predetermined location, upon a control program, and/or based upon an operator releasing the platform (manually or remotely). As shown in FIGS. 1-6, the movable members 204 can be flexible members. The flexible members can be cables, chains, ropes, fiberoptics, cords, or any other suitable member. In other embodiments, as shown in FIGS. 7-9, the movable members 204 can be selectively rigid or rigid. The selectively rigid members can be a chain (see FIG. 7) as shown in U.S. Patent Application No. 2009/0026018, which is hereby incorporated by reference in its entirety. The rigid members can be scissor members (see FIG. 8) or hydraulic members (see FIG. 9).

The body 108 can be any suitable body. As shown in FIG. 1-2, the body 108 can be a truss for a theatrical display. Similarly, the body 108 can be scaffolding, a roof, a ceiling, an archway, a series of cables, a stage, or any other suitable structure. In one embodiment, the body 108 is a fixed body substantially prevented from movement. In another embodiment, the body 108 is capable of selective movement.

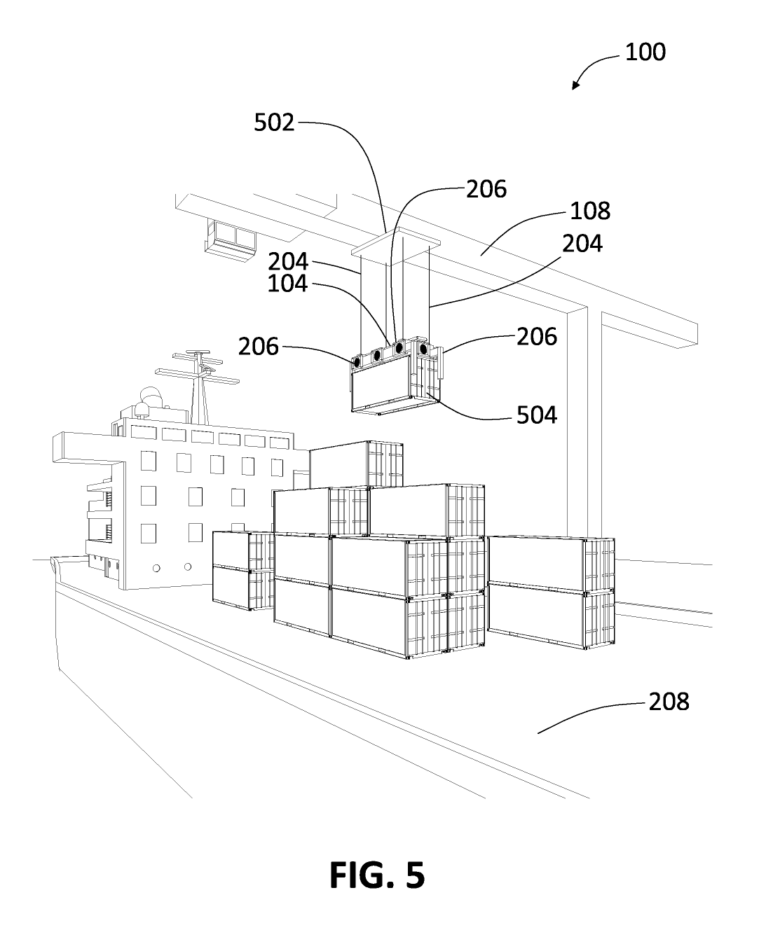

As shown in FIGS. 5-6 and 10-11, the body 108 can be a crane 502. The crane 502 can position the platform 102 (for example, a roof of a cargo container 504 or an independent portion attachable to the cargo container 504) by moving in a rotational direction and an elevational direction. While the crane 502 moves the cargo container 504, the gyroscopes 106 can be selectively (manually or automatically) engaged to accelerate at a predetermined rate and/or move at a predetermined velocity. In one embodiment, the crane 502 moves along a predetermined rotational path and the gyroscopes 106 counteract movement of the crane 502 thereby stabilizing the platform 102. Use of the gyroscopes 106 can thus permit the crane 502 to operate during conditions of higher wind, in regions with higher wind (for example, on ships or off-shore oil rigs), and in conjunction with a broader range of weights for cargo containers 504. In one embodiment, the crane 502 can be operated with substantially empty cargo containers 504 and the gyroscopes 106 reduce or eliminate swaying of the cargo container 504 generated from movement of the crane 502. In another embodiment, the crane 502 can be operated with a substantially full cargo container 504 and the gyroscopes reduce or eliminate swaying of the cargo container 504 generated from movement of the crane 502. In a further embodiment, the gyroscopes 106 can reduce or eliminate swaying of the cargo container 504 generated from movement of the crane 502 while the cargo container 504 is substantially empty, substantially full, or partially full. Likewise, the gyroscopes 106 can stabilize the platform 102 when on a ship and the entire ship rocks in the water. The size of the gyroscopes 106 can correspond to the width of the platform 102. For example, as shown in FIGS. 10-11, the gyroscopes 106 can have a large size and/or mass to correspond loads to the platform 102 having a large size and/or mass. Additionally or alternatively, the gyroscopes can be selected based upon the anticipated external forces being applied to the platform 102. For example, as shown in FIG. 10, the motion control mechanism 104 (or a portion of the motion control mechanism 104 such as one or more of the gyroscopes 106) can be positioned horizontally relative to the platform 102 in an environment with large winds. As shown in FIG. 11, the motion control mechanism 104 (or a portion of the motion control mechanism 104 such as one or more gyroscopes 106) can be positioned vertically in an environment having substantial elevational lifting of the platform 102.

In one embodiment, the body 108 is a ground-supported body. As shown in FIG. 7, the body 108 (shown transparent in FIG. 7 to illustrate the collapsibility of the chain) can rest on the ground or can be secured to the ground. As shown in FIG. 8-9, the body 108 can be a vehicle. The vehicle can be configured for operation only while the platform 102 is extended, can be configured for operation only when the platform 102 is retracted, can be configured for operation only while the platform 102 is retracted or extended, can be configured for operation while the platform 102 is being retracted, or can be configured for operation at any time. In one embodiment (see FIG. 9), the vehicle can be secured to the ground.

The motion control mechanisms 104 and/or gyroscopes 106 can be manually and/or automatically engaged and/or disengaged to operate in a coordinated manner to compensate for one or more external forces and/or to generate one or more internal force. In one embodiment, a control system (not shown) executes a predetermined process for controlling one or more of the motion control mechanisms 104 and/or the gyroscopes 106 (for example, an executable computer program). The process can include measuring the external force, analyzing the external force to identify one or more force vectors, sending a signal to one or more motion control mechanisms 104 and/or gyroscopes 106 corresponding with the one or more vectors, determining whether the external force continues, repeating accordingly, and responsively adjusting or maintaining the motion control mechanism 104 as described above. The sensors can be anemometry, one or more accelerometers, any other suitable sensor, or any suitable combination thereof.

In one embodiment, the control system incorporates a routine based upon external forces anticipated to be generated. For example, the routine can be a dance routine to be performed by an individual on the platform 102. As music is performed, the motion control mechanisms 104 are activated and deactivated based upon movement that is part of the dance routine. In a predetermined routine, the individual can make jump forward, jump backward, jump to either side, and/or make arm movements. With these movements being predetermined, the motion control mechanisms 104 can be activated concurrent to the movement being made thereby reducing or eliminating the affect of the generated external force upon movement of the platform 102.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A system, comprising:
a platform;
a motion control mechanism affixed to the platform;
a body; and
one or movable members extending between the platform and the body to support the platform;
wherein the one or more movable members connect the platform to the body;
wherein the motion control mechanism is configured to provide a force to substantially maintain a relative position of the platform in response to an external force being applied to at least one of the one or more movable members or the platform or the motion control mechanism is configured to adjust the relative position of the platform by generating an internal force.

2. The system of claim 1, wherein the external force is generated by movement of the one or more movable members.

3. The system of claim 1, wherein the external force is generated by movement of the body.

4. The system of claim 1, wherein the external force is wind.

5. The system of claim 1, wherein the motion control mechanism is configured to substantially maintain a relative distance between a plurality of locations on the platform and a surface.

6. The system of claim 1, wherein the motion control mechanism is configured to substantially maintain a relative distance between a plurality of locations on the platform and the body.

7. The system of claim 1, wherein the motion control mechanism includes one or more gyroscopes.

8. The system of claim 7, wherein the one or more gyroscopes is arranged for maintaining the relative position of the platform in response to the external force being substantially consistent with the orientation of the one or more movable members.

9. The system of claim 7, wherein the one or more gyroscopes is arranged for maintaining the relative position of the platform in response to the external force being substantially perpendicular with the orientation of the one or more movable members.

10. The system of claim 7, wherein the one or more includes a first gyroscope having a first orientation and a second gyroscope having a second orientation, the first orientation differing from the second orientation.

11. The system of claim 7, wherein the motion control mechanism is configured to adjust the relative position of the platform by generating the internal force and the one or more gyroscopes is selected to have a mass, velocity, or combination thereof sufficiently large such that the external force has a negligible effect on the relative position of the platform.

12. The system of claim 7, wherein the motion control mechanism is configured to adjust the relative position of the platform by generating the internal force, the internal force being in a direction tangential to at least one of the one or more gyroscopes.

13. The system of claim 1, wherein the body includes a crane.

14. The system of claim 1, wherein the body includes a winch.

15. The system of claim 1, wherein the platform is configured to detachably engage a container.

16. The system of claim 1, wherein the motion control mechanism is positioned in a first orientation relative to the platform and is configured to be adjusted to a second orientation relative to the platform.

17. The system of claim 1, wherein the motion control mechanism is configured to halt and restart dynamically in relation to the relative position of the platform.

18. The system of claim 1, wherein the motion control mechanism is capable of generating torsional movement of the platform.

19. A process of providing motion control to a system having a platform, a motion control mechanism, and a body, the process comprising:
supporting the platform with one or more movable members extending between the platform and the body;
providing a force to maintain a relative position of the platform with the motion control mechanism in response to an external force being applied to at least one of the one or more movable members or the platform or generating an internal force to adjust the relative position of the platform.

20. A process of controlling motion of a system, the process comprising:
providing a force to substantially maintain a relative position of a platform in response to an external force being applied to at least one of one or more movable members or the platform or generating an internal force to adjust the relative position of the platform.
